(19) United States
(12) Patent Application Publication
(10) Pub. No.: US 2003/0164085 A1
(43) Pub. Date: Sep. 4, 2003

(54) Surround sound system

(76) Inventor: Robert Morris, Delta (CA)

Correspondence Address: David J Heller, Ridout & Maybee, Suite 2400, One Queen Street East, Toronto, ON, M5C 3B1, CA

(21) Appl. No.: 10/362,179

(22) PCT Filed: Aug. 17, 2001
(86) PCT No.: PCT/CA01/01184

(51) Int. Cl. G10H 1/02; G01P 3/00

(52) U.S. Cl. 84/626

(57) ABSTRACT

A sound generation system for proving surround sound includes a sound generation means, a plurality of sound channels and a recording means. The sound generation means is for operation by a user to generate sounds and includes a plurality of interface members for generating sounds. Each interface member is operable by the user to generate an associated sound. The plurality of sound channels is for receiving sound from the plurality of interface members. Each interface member in the plurality of interface members is connected to a distinct associated channel in the plurality of sound channels to transmit the associated sound to the distinct associated channel. The recording means is for recording sound from each sound from each channel in the plurality of sound channels.

### FIELD OF THE INVENTION

The present invention relates generally to musical instruments and more particularly relates to surround sound music systems.

### BACKGROUND OF THE INVENTION

On the production end, surround sound systems typically include speakers, a recording console, and one audio channel for each surround channel offered by the recording console. The audio data from the various audio channels is then decoded at the consumer end using a surround compatible amplifier, a DVD player or a stand alone decoder. In surround sound systems, the surround compatible console can send different signals along distinct audio channels to distinct speakers such that different sounds will be emitted by distinct speakers. As a result, a listener positioned so that distinct speakers are in different directions, will hear different sounds from these different directions, thereby creating a three-dimensional type effect. This effect is frequently used in movie-theaters, where the impression of movement can be given by moving a sound, say a helicopter sound, through a sequence of speakers spaced throughout the sound environment.

These effects can be further enhanced through the use of audio effector units. One example of an audio effector unit is a electronic effect/delay unit, which can be used to create looping in which a sequence of different notes or chords is played over and over again, or a sustained note or group of notes sounded simultaneously and continuously for varying lengths of time (a drone). Optionally, this looping may be rendered multi-directional by moving the sequence between different speakers. Specifically, sound can be “ping ponged” back and forth between different speakers, or may be circulated through different speakers. Sound may be instantaneously switched between different speakers or may be “panned” between different speakers where channels to different speakers are sequentially and continuously opened and closed to have the effect of sound dying out at one speaker while it is being transferred to another speaker. The electronic effect/delay unit has a mono input linked to the surround compatible console or directly to a miked instrument, and a mono or stereo output through which, via the surround compatible console, the unit can be connected to different speakers via different output audio channels.

Other effector units include units that provide sampling, looping, harmonizing, delays, reverberation and infinite repeat loops. For example, harmonizers can provide reverberation, delay and can also harmonize. Samplers can be used to provide alternative sound sources that are triggered by the guitar via voltage to midi converters. For example, a guitar note received by a sampler via a mono input could be converted by the sampler into another musical note exclusive of a guitar, say a piano note. These new sounds are then sent to the surround compatible recording console and from there can be sent anywhere in the surround environment.

At their present stage of development, surround sound systems permit the enhancement and modification of previously created music. However, surround sound technology has not been integrated into the initial creation of the music, except where music is created by re-mixing previously created music. Specifically, the musician has not been able to play with directing individual components of the music between different speakers when actually creating the music. Accordingly, a surround sound musical instrument that enables musicians to use surround sound technology in the actual creation of the music is desirable.

### SUMMARY OF THE INVENTION

An object of an aspect of the present invention is to provide an improved sound generation system.

In accordance with an aspect of the present invention, there is provided a sound generation system for providing surround sound via a plurality of spaced speakers. The sound generation system includes a sound generation means for operation by a user to generate sounds. The sound generation means has a plurality of interface members for generating sounds. Each interface member is operable by the user to generate an associated sound. The sound generation system further includes a plurality of sound channels for receiving sound from the plurality of interface members. Each interface member in the plurality of interface member is connected to a distinct associated channel in a plurality of sound channels that transmit the associated sound to the distinct associated channel. Further, the sound generation system includes a sound-directing means for allocating the associated subset of sounds for each sound channel in the plurality of sound channels to at least one speaker in the plurality of spaced speakers. The sound-directing means is connected to the plurality of sound channels and is connected to the plurality of speakers via a plurality of speaker channels.

Preferably, the sound generation means is a musical instrument. Conveniently, this musical instrument is a stringed musical instrument, and the plurality of interface members are a plurality of strings of the musical instruments.

In accordance with a second aspect of the present invention, there is provided a sound generation system for providing surround sound. The sound generation system includes a sound generation means for operation by user to generate sounds. The sound generation means has a plurality of interface members for generating sounds. Each interface member is operable by the user to generate an associated sound. A sound generation system also includes a plurality of sound channels of receiving sound from the plurality of interface members. Each interface member in the plurality of interface member is connected to a distinct associated channel in the plurality of sound channels to transmit the associated sound to the distinct associated channel. The sound generation system further includes recording means for recording sound from each channel in the plurality of sound channels.

Preferably, the recording means includes a plurality of ports for receiving the plurality of sound channels. Each channel in the plurality of sound channels is connected to an associated port in the plurality of ports. The recording means also includes a replay means for transmitting the sound recorded from each channel in the plurality of sound channels via a selectable port in the plurality of ports.

### BRIEF DESCRIPTION OF THE DRAWINGS

Reference will now be made, by way of example, to the accompanying drawings, which show preferred aspects of the present invention, and in which:

FIG. 1, in a schematic view, illustrates an embodiment of a musical instrument component of a surround sound system in accordance with the preferred embodiment of the present invention;

FIG. 2, in a schematic view, illustrates an aspect of a mult/patch bay component of the surround sound system of FIG. 1;

FIGS. 3 and 4, in schematic views, illustrate audio effect aspects of a sound processing component of the surround sound system of FIG. 1; and,

FIG. 5, in a schematic view, illustrates an aspect of a surround compatible console component of the surround sound system of FIG. 1.

### DETAILED DESCRIPTION OF PREFERRED ASPECTS OF THE INVENTION

When an audio engineer or a film sound mixer uses a surround sound system it is generally to place special audio effects into the 3-D realm or for mixing sound to create greater ambience in pre-recorded program material. For instance, a jazz quintet could be mixed to have the piano emanating from one speaker, the bass from another, the vocals from yet another and so on. This can be referred to as 3-D mixing, and creates an atmospheric ambience in the recording. However, none of the individual instruments can be played or recorded three dimensionally on their own. In contrast and in accordance with an embodiment of the present invention, each of the strings of an instrument can be allocated to its own audio channel, and hence placed anywhere in a 3-D surround spectrum.

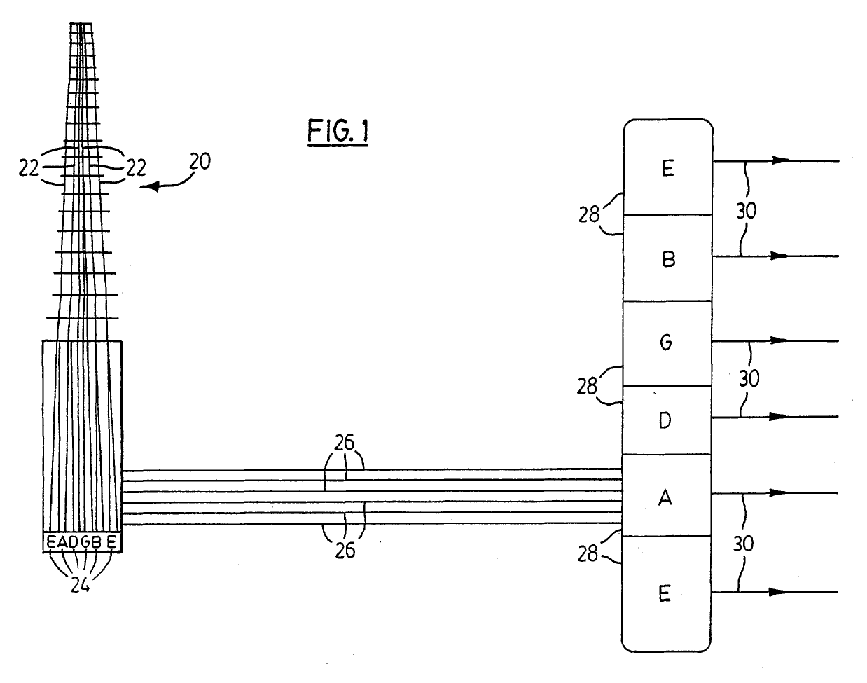

Referring to FIG. 1, there is illustrated a Gittler guitar 20 having six strings 22. The Gittler guitar is an electrical guitar invented in the late 1970s by Allan Gittler and is described in U.S. Pat. No. 4,079,652, which is incorporated by reference. The Gittler guitar 20 has six linear pickups 24. Six guitar output lines 26 are linked to the Gittler guitar 20. Each one of the guitar output lines 26 is linked to a separate linear pickup 24. Each of the guitar output lines 26 is linked to a pre-amplification module 28 that brings the signal from the low impedance guitar up to an acceptable level. This signal is then output from the pre-amplification modules 28 via pre-amplification outlets 30.

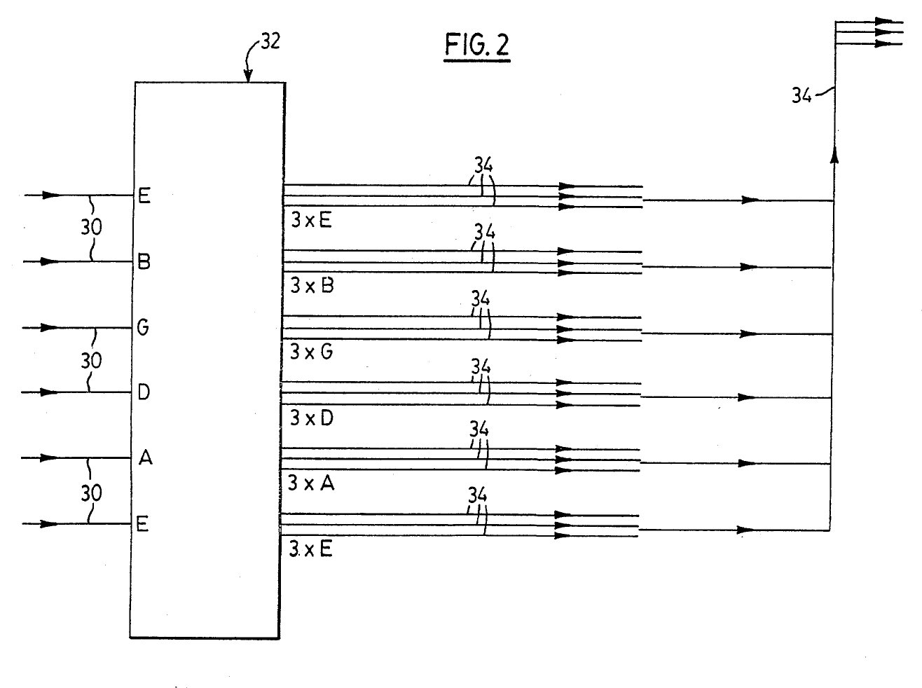

Referring to FIG. 2, pre-amplification outlets 30 are shown connected to a mult/patch bay unit 32. The mult/patch bay unit 32 takes the input signals from the pre-amplification outlets 30 and creates multiple outputs of the same signal for each of the input signals. These multiple output signals are output via mult output lines 34, each of which can be directed to distinct processors. In FIG. 2, three distinct mult output lines 34 are shown for each of the strings of the guitar; however, for ease of representation, these three distinct mult output lines 34 for each string of the guitar are eventually reduced to one mult output line 34 for each string of the guitar. This total of six mult output lines 34 are then further reduced, at the right-hand side of FIG. 2, to a single mult output line 34, and then expanded again to a total of three mult output lines 34. In the actual embodiment, these mult output lines 34 would all be kept separate—there would be eighteen (three for each of the six strings) mult output lines in total.

As a result of having a distinct pickup for each string 22 of the guitar 20, the notes from different strings can be assigned to different audio inputs on a recording console and from thence to different speakers. The fact that sound and music created by different strings can be directed to different speakers and heard by a listener from different directions, gives a listener within the surround environment the impression of being inside the instrument itself. Further, the fact that the musician can individually and dynamically control the direction from which the listener will hear the notes from each individual string makes the surround environment a part of the performance of the music. In other words, the musician is able to redirect sounds from different strings to different speakers to vary the overall musical effect.

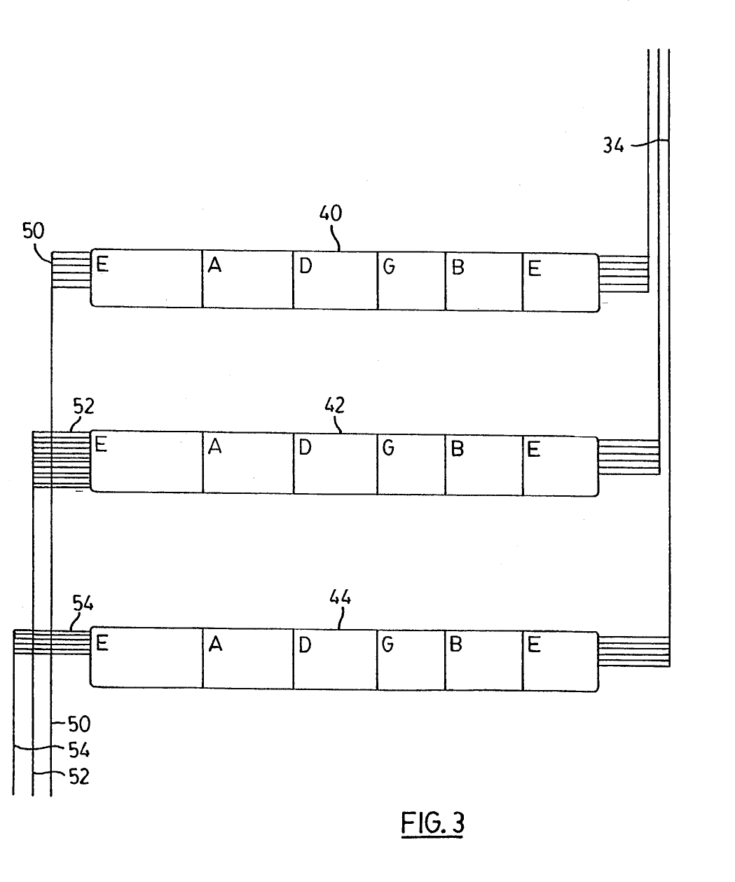

The notes from each string can be processed in multiple ways due to the generation of multiple signals for each string by the mult/patch bay unit 32. Referring to FIG. 3, various audio effector boxes for processing the signal received from each of the strings are illustrated. One of the audio effector boxes permits sampling. Specifically, six of the mult output lines 34 lead into a midi converter 40 that converts the six voltages into midi. Using the midi converter 40, the guitar 20 can be used to trigger any combination of sample sounds stored on a sampler associated with the midi converter 40. Specifically, by playing a specific note on a specific string, and transmitting the signal thus generated to the midi converter 40, a sample sound not conventionally playable by a guitar, such as a piano sound say, can be triggered by the midi converter 40 sending a midi signal to the sampling unit.

Six of the mult output lines 34 lead into a sampling/signal processor 42. This processor 42 has a mono or stereo input for each string, and a stereo output. Accordingly, although there are six mult outputs leading into the processor 42, twelve processor output lines 52 lead from the processor 42. Using the processor 42, looping can be created. Optionally, this looping may be rendered multi-directional by moving the sequence between different speakers. The signals generated by the processor 42 are then output via processor output lines 52.

Six mult output lines 34 lead into harmonizer 44. Harmonizer 44 also creates loops, and can also, for any note received as an input, provides reverberation, delay and harmonization. Harmonizers harmonize by playing a note at some specific interval above the first note received.

The midi converter 40, processor 42 and harmonizer 44 are all examples of audio effector boxes that take an audio signal and manipulate that signal or generate new signals based on the signal received before releasing an output. Many different kinds of audio effector boxes can be used. Combining these audio effector boxes with the ability to direct different sounds generated simultaneously from the same guitar to different guitar output lines 26, exponentially increases the creative freedom of the musician, in that the musician is not only able to direct different notes played to different speakers, but is also able to process these different notes differently before transmitting the processed notes from each speaker.

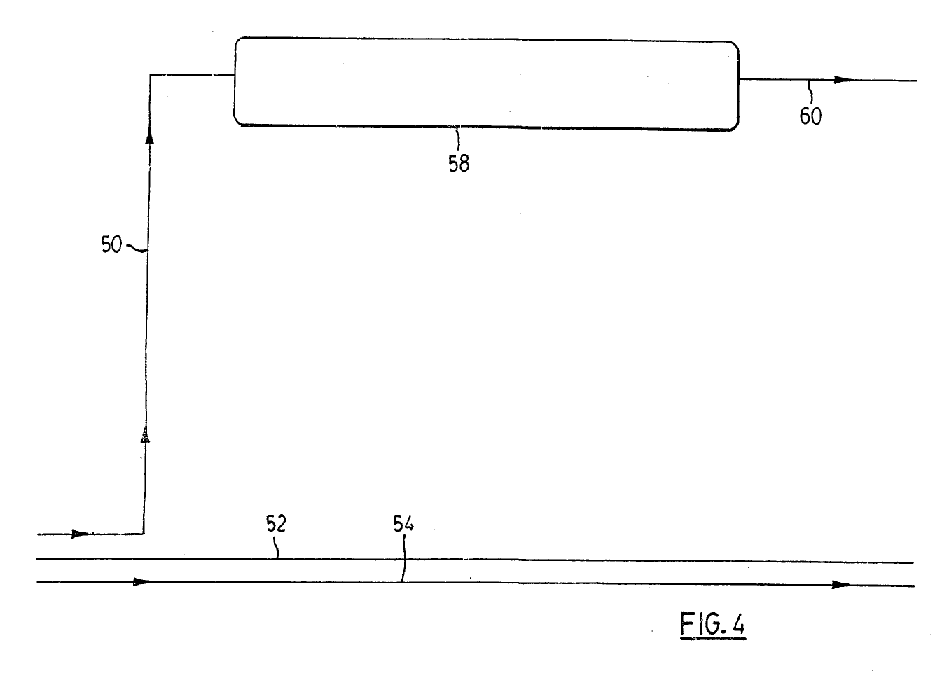

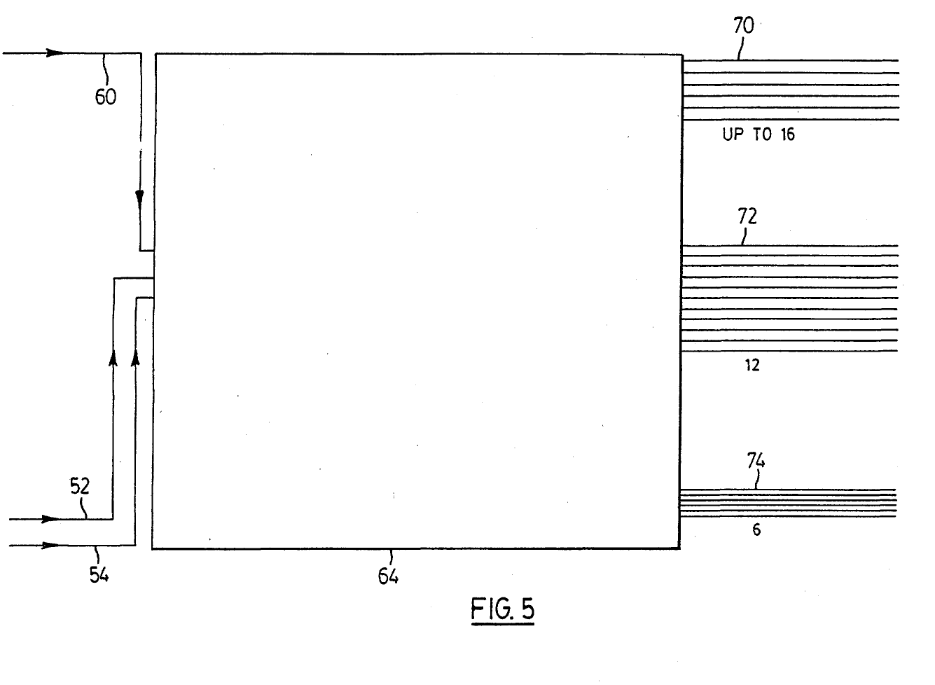

Referring to FIG. 4, a sampler 58 for the midi converter is illustrated. Specifically, midi output lines 50 are connected to the sampler 58 at a midi input of the sampler 58. At the midi converter 40, notes from the guitar 20 were converted into digital signals. These digital signals are then transmitted to the sampler 58 via midi output lines 50. At the sampler 58, the digital signals are then converted into musical notes that may be exclusive of a guitar, such as, say, a piano note. These audio signals are then output via sampler output line 60. Referring to FIG. 5, sampler output line 60, processor output lines 52, and harmonizer output lines 54 are all fed into a digital surround compatible console 64 that is used to mix the 3-D sounds and to allocate these sounds to any speaker in the surround environment. The up to sixteen sampler signals, twelve processor signals and six harmonizer signals are then transmitted to the speakers via audio channels 70, 72 and 74 respectively.

It will be appreciated by those skilled in the art, that the particular audio effector boxes used, indeed the use of any audio effector boxes, are not essential to the invention. They merely demonstrate some of the advantages flowing from the implementation of the invention. The invention could also be implemented by linking guitar output lines 26 directly to the surround compatible console 64, without either the speakers or the audio effector boxes. Then, once the. music had been recorded, the musician can interact with the recorded music by directing different parts of the instrument to different speakers. Alternatively, the invention could be implemented by linking guitar output lines 26 directly to the surround compatible console 64 and from thence to the speakers. The musician would still be able to direct individual notes from individual strings to different speakers, thus enabling the musician to play with this surround environment as an inherent part of the creative process.

Surround compatible console 64 is a means through which to channel the notes of an electronic instrument (or the strings of a Gittler guitar) to the various amplifiers and speakers in the surround environment. This allows one to take a plurality of analogue signal sources, convert them to the digital domain, manipulate them and direct them to the surround environment. The signals are then reconverted to analogue signals and sent out the auxiliary outputs (sends) to the amplifiers and speakers.

In another embodiment, this process can be achieved within a software program referred to as a recording platform. Digital audio recording platforms may incorporate an internal mixing console and may support surround mixing options. To use this approach in the present invention another piece of hardware, namely an analogue to digital, digital to analogue converter may be used. In a preferred embodiment, a minimum of six inputs and six outputs are used. The number of inputs and outputs may vary to correspond with the manner of surround sound system used, and could include various numbers of channels and sound sources.

In another embodiment, the invention includes hardware such as a joystick or a programmable midi controller as a means of manipulating the individual channel's location in the surround environment. Such digital audio platforms allow one to take recorded material and mix it into the surround environment. Thus, sounds that are being input into the recording platform can be manipulated at will during a performance. Thus the present invention teaches a three dimensional sound generating device.

It will be further appreciated by those skilled in the art, that although the foregoing description is of aspects of the invention as implemented using a Gittler guitar, the invention might well be implemented using other musical instruments by permitting different notes from these musical instruments to be directed to different speakers. For example, on a keyboard, different notes might be allocated to different speakers. Specifically, whenever a musician performs a distinct act by, say, striking a particular key on a keyboard, or a string on a guitar, the musician playing an instrument in accordance with the present invention could also direct the sound resulting from this act to a specific speaker. Accordingly, other variations and modifications of the invention are possible. All such modifications or variations are believed to be within the sphere and scope of the invention as defined by the claims appended hereto.

What is claimed is:

1. A sound generation system for providing surround sound via a plurality of spaced speakers, the sound generation system comprising:
a sound generation means for operation by a user to generate sounds, the sound generation means having a plurality of interface members for generating sounds, each interface member being operable by the user to generate an associated sound;
a plurality of sound channels for receiving sound from the plurality of interface members, each interface member in the plurality of interface members being connected to a distinct associated channel in the plurality of sound channels to transmit the associated sound to the distinct associated channel; and,
a sound-directing means for allocating the associated subset of sounds for each sound channel in the plurality of sound channels to at least one speaker in the plurality of spaced speakers, the sound-directing means being connected to the plurality of sound channels, and being connected to the plurality of speakers via a plurality of speaker channels.

2. The sound generation system as defined in claim 1 wherein the sound generation means is a musical instrument.

3. The sound generation system as defined in claim 2 wherein
the musical instrument is a stringed musical instrument; and,
the plurality of interface members are a plurality of strings of the musical instrument.

4. The sound generation system as defined in claim 3 wherein the stringed musical instrument comprises a plurality of string pickups, the plurality of string pickups having, for each string in the plurality of strings, an associated string pickup for receiving the sound generated by the string, the associated string pickup being connected to the associated sound channel in the plurality of sound channels.

5. The sound generation system as defined in claim 4 wherein the stringed musical instrument is a Gittler guitar.

6. A sound generation system for providing surround sound, the sound generation system comprising:
a sound generation means for operation by a user to generate sounds, the sound generation means having a plurality of interface members for generating sounds, each interface member being operable by the user to generate an associated sound;
a plurality of sound channels for receiving sound from the plurality of interface members, each interface member in the plurality of interface members being connected to a distinct associated channel in the plurality of sound channels to transmit the associated sound to the distinct associated channel; and,
recording means for recording sound from each channel in the plurality of sound channels.

7. The sound generation system as defined in claim 6 wherein the recording means has
a plurality of ports for receiving the plurality of sound channels, each channel in the plurality of sound channels being connected to an associated port in the plurality of ports; and,
replay means for transmitting the sound recorded from each channel in the plurality of sound channels via a selectable port in the plurality of ports.

8. The sound generation system as defined in claim 7 wherein the sound generation means is a musical instrument.

9. The sound generation system as defined in claim 8 wherein
the musical instrument is a stringed musical instrument; and,
the plurality of interface members are a plurality of strings of the musical instrument.

10. The sound generation system as defined in claim 9 wherein the stringed musical instrument comprises a plurality of string pickups, the plurality of string pickups having, for each string in the plurality of strings, an associated string pickup for receiving the sound generated by the string, the associated string pickup being connected to the associated sound channel in the plurality of sound channels.

11. The sound generation system as defined in claim 10 wherein the stringed musical instrument is a Gittler guitar.

12. The sound generation system as defined in claim 2 further comprising a sound channel dividing means for dividing each sound channel in the plurality of sound channels into an associated plurality of subsidiary channels, each sound channel in the plurality of sound channels being connected to the sound directing means via the associated plurality of subsidiary channels.

13. The sound generation system as defined in claim 12 further comprising a plurality of audio effect units for providing audio effects based on the sounds generated, wherein each channel in the plurality of sound channel has an audio effect subsidiary channel in the plurality of subsidiary channel, the audio effect subsidiary channel being connected to an associated audio effect unit in the plurality of audio effect units.

14. The sound generation system as defined in any one of claims 1 to 13, wherein said surround-directing means comprises recording platform software.

15. The sound generation system as defined in claim 14 wherein said surround-directing means comprises an analogue to digital, digital to analogue converter.

16. The sound generation system as defined in claim 15 wherein said analogue to digital, digital to analogue converter has a minimum of six inputs and six outputs.

17. The sound generation system as defined in any one of claims 1 to 16 further comprising a manipulating apparatus to manipulate an individual channel's sound location.

18. The sound generation system as defined in claim 17 wherein said manipulating apparatus is a joystick.

19. The sound generation system as defined in claim 17 wherein said manipulating apparatus is a midi controller.
